(19) United States
(12) Patent Application Publication
(10) Pub. No.: US 2005/0162843 A1
(43) Pub. Date: Jul. 28, 2005

(54) Tip to tail to center pointer

(75) Inventors: Chay Lee, Warren, MI (US); Vyacheslav B. Birman, Rochester Hills, MI (US); Werner Eckardt, Rochester, MI (US)

Correspondence Address: SIEMENS CORPORATION;INTELLECTUAL PROPERTY LAW DEPARTMENT, 170 WOOD AVENUE SOUTH, ISELIN, NJ, 08830, US

(73) Assignee: Siemens VDO Automotive Corporation, Auburn Hills, MI (US)

(21) Appl. No.: 10/984,332

(22) Filed: Nov. 9, 2004

Related U.S. Application Data
(60) Provisional application No. 60/538,488, filed on Jan. 22, 2004.

(51) Int. Cl. G01D 11/28

(52) U.S. Cl. 362/30

(57) ABSTRACT

A pointer includes a diffuser that receives light from a single light source and reflects light toward a tip and a tail of the pointer uniformly regardless of radial position. Transmission of light toward a tip and a tail of the pointer is accomplished by a reflective surfaces within the pointer. A diffuser is disposed adjacent the reflective surfaces to provide an even luminance throughout the pointer. The light source produces light that is transferred through a translucent shaft toward the diffuser. The diffuser is aligned with light transmitted through the shaft. The light source is disposed along the axis such that rotation of the pointer does not change the relative orientation between the light source and the reflective surfaces. The consistent relative orientation between the light source and the pointer substantially eliminates differences in illumination levels produced during rotation about the axis.

The application claims priority to U.S. Provisional Application No. 60/538,488 which was filed on Jan. 22, 2004.

### BACKGROUND OF THE INVENTION

This invention generally relates to an illuminated pointer for an instrument panel. More particularly, this invention relates to an illuminated pointer that provides consistent and continuous luminance along the entire length of the pointer utilizing a single light source.

An Instrument panel for a vehicle includes several gauges for displaying and conveying information to a driver. The instrument panel typically includes a speedometer along with other gauges such as a tachometer, battery level indicator, and oil pressure gauge. Typically a pointer is mounted to move relative to a fixed graphical image on each gauge.

The pointer is typically one of two basic types, either a non-active pointer or an active pointer. A non-active pointer is illuminated by a light source mounted to a circuit board positioned behind a light transparent output shaft. Light is reflected into the pointer and scattered to illuminate the pointer. An active pointer includes a light source secured to the moving pointer. In some instances the pointer is illuminated from a tip to a tail portion or from a center to the tip to provide a desired appearance.

Pointers that are illuminated from the tip to the tail or from the center to the tip typically are mounted to a metallic shaft and use a transparent light guide that directs light to reflective surfaces of the pointer. In some pointers, multiple light sources are utilized that direct light to reflective surfaces. A multiple light source pointer system typically includes a stem with a radial surface that extends outwardly from a shaft axis. The pointer includes multiple reflective surfaces that reflect light along the pointer in several radial positions. The multiple light source pointer may include an opaque part utilized to reduce luminance emitted through the center or the tail areas of the pointer.

Disadvantageously, such systems require either multiple light sources or a light guide. Light emitted from multiple sources and directed onto reflective surfaces of the pointer provides undesirable variance in luminance levels as the pointer rotates. Further the use of a light guide or multiple light sources increases complexity that in turn increases cost and reduces reliability.

Accordingly, it is desirable to develop and design a simple pointer system that provides tip to tail or center to tip illumination that is consistent and continuous during operation.

### SUMMARY OF THE INVENTION

This invention is a pointer that includes a diffuser that receives light from a single light source and reflects light toward a tip and a tail of the pointer uniformly regardless of radial position.

The pointer is illuminated to provide a desirable visual reference on scales of a gauge such as a speedometer. The pointer is an elongated rectangular member including a tip, a tail and a center. Light is emitted through the pointer from the center to the tip and to the tail. Transmission of light to the tip and to the tail is accomplished through the use of reflective surfaces formed within the pointer. A diffuser reflects light that enters the pointer and controls luminance through the center.

The pointer is supported on a shaft that is rotated by a motor supported within a housing. A light source is disposed along the axis of rotation and mounted to a printed circuit board (PCB). The light source produces light that is transferred through a translucent shaft and toward the diffuser. The diffuser is received within a cavity of the pointer and is positioned such that a first reflective surface and a second reflective surface are aligned with light transmitted through the shaft. The light source is disposed along the axis such that rotation of the pointer does not change the relative orientation between the light source and the diffuser. The consistent relative orientation between the light source and the pointer substantially eliminates differences in illumination levels produced during rotation about the axis.

Accordingly, the example pointer of this invention provides a tip to tail or center to tip illumination that is consistent and continuous during operation.

These and other features of the present invention can be best understood from the following specification and drawings, the following of which is a brief description.

### BRIEF DESCRIPTION OF THE DRAWINGS

FIG. 1 is a plan view of a speedometer including an example illuminated pointer according to this invention.

FIG. 2 is a perspective view of the example illuminated pointer according to this invention.

FIG. 3 is a cross-sectional view of the example illuminated pointer according to this invention.

FIG. 4 is a cross-sectional view of another illuminated pointer according to this invention.

FIG. 5 is a top view of a diffuser according to this invention.

FIG. 6 is a side view of the diffuser according to this invention.

FIG. 7 is a cross-sectional view of the pointer.

FIG. 8 is a perspective view of a cap attached to the pointer.

FIG. 9 is a perspective view of a bottom side of the cap.

FIG. 10 is a perspective view of the pointer and diffuser according to this invention.

FIG. 11 is a perspective view of the pointer, diffuser and cap according to this invention.

### DETAILED DESCRIPTION OF THE PREFERRED EMBODIMENT

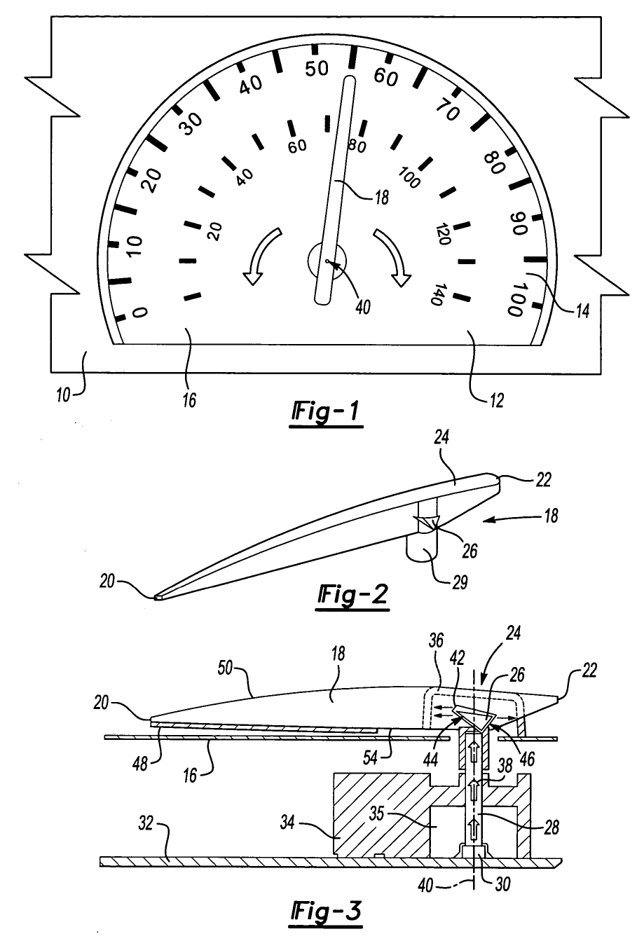

Referring to FIG. 1 an instrument panel 10 includes a speedometer 12. The speedometer 12 includes a graphical image 16 that includes a scale 14 disposed radially about an axis of rotation 40. A pointer 18 rotates about the axis 40 to point to a specific number on the scale 14. The pointer 18 is illuminated to provide a desirable visual reference on the scale 14. As appreciated, although a speedometer 12 is shown, other gauges that are known to those skilled in the art are also within the contemplation of this invention.

Referring to FIG. 2, the pointer 18 provides consistent lighting throughout the entire range of movement along the speedometer 12. The pointer 18 is a generally elongated rectangular member including a tip 20, a tail 22 and a center 24. The pointer 18 is supported atop a shaft adaptor 29. Light is emitted through the pointer 18 from the center 24 toward the tip 20 and toward the tail 22. The pointer 18 includes a first reflective surface 44 and a second reflective surface 46. The diffuser 26 is disposed within the center 24 and adjacent the first and second reflective surfaces 44, 46. The diffuser 26 controls transmission of light through the center 24.

Referring to FIG. 3, the pointer 18 is supported on a shaft 28 that is rotated by a motor 35 supported within a housing 34. The motor 35 is preferably an electric stepper motor to control movement of the pointer 18 relative to the scale 14. Although, a stepper motor is preferred, other motors as are known are within the contemplation of this invention.

The housing 34 and motor 35 are supported on a printed circuit board 32 (PCB). The PCB 32 includes a light source 30. The light source 30 in the example embodiment is a light emitting diode. The light emitting diode may emit any color that is desired for a specific application. Further, the light emitting diode may provide for the variation of light intensity. As appreciated, a worker with the benefit of this disclosure would understand that any light source utilized for instrument panel lighting is within the contemplation of this invention.

The light source 30 produces light 38 that is transferred through the shaft 28 and toward the diffuser 26. The shaft 28 in the example embodiment is fabricated from a translucent material that provides a guide between the light source 30 and the pointer 18.

A cap 36 covers a portion of the pointer 18 adjacent the center 24. The cap 36 engages and holds the diffuser 26 in place within the pointer 19. The cap 36 blocks the emission of light from other sources that may leak through the instrument panel 10. The cap 36 prevents light that is not directed through the pointer 18 from becoming visible.

The pointer 18 includes a cavity 42 for the diffuser 26. The diffuser 26 is received within the cavity 42 and is positioned adjacent the first reflective surface 44 and the second reflective surface 46 that are in turn aligned with light 38 transmitted through the shaft 28. The diffuser 26 controls the amount of light 38 that is transmitted straight through the center 24.

The light source 30 is disposed along the axis 40 such that rotation of the pointer 18 does not change the relative orientation between the light source 30 and the diffuser 26. The consistent relative orientation between the light source 30 and the pointer 18 substantially eliminates differences in illumination levels produced during rotation about the axis 40. The consistent relative orientation between the light source 30 and the diffuser 26 provide the uniform light levels that are emitted from the tip 20 to the tail 22 of the example pointer 18.

The pointer 18 is generally an elongate member having a top surface 50 and a bottom surface 54. The top surface 50 is curved to provide for the transmission of light from the center 24 to the tip 20 and to the tail 22. The curved shape is provided to reflect light outwardly as desired. The bottom surface 54 is substantially flat and partially covered with a reflective coating 48. The reflective coating 48 prevents light emission through the bottom surface 54 and onto the graphical display 16. Further the reflective coating 48 reflects light upward to the top surface 50.

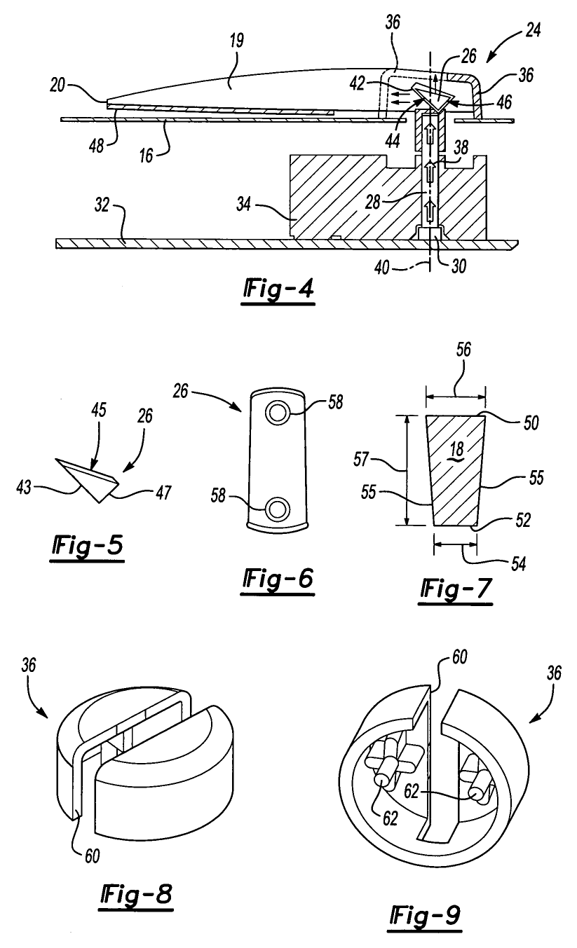

Referring to FIG. 4 another example pointer 19 is shown that includes a tip 20 and a center 24 and no significant tail. Light from the light source 30 is transmitted through the shaft 28 to the reflective surfaces 44, 46 and the diffuser 26. Only the first surface 44 that is aligned with the light source 30 such that light is not reflected toward the rear of the pointer 19. The diffuser 26 reduces the luminance at the center 24. Reducing the luminance at the center 24 eliminates a bright spot that may otherwise form because of the initial reflection point of the light 38 on the diffuser 26 as it travels through the translucent shaft 28. A cap 36 is disposed about the pointer 19 at the center 24 and engages the diffuser 26.

Referring to FIGS. 5 and 6, the diffuser 26 is shown and includes the top surface 45 that is substantially an elongate rectangular shape. The diffuser 26 includes openings 58 that engage the cap 36. The diffuser 26 in the example embodiment is longer than a width of the pointer 18 such that the openings 58 are exposed on opposite sides of the pointer 18. The diffuser 26 includes a substantially triangular cross-section that includes a first side 43, a second side 47 and the top surface 45. The first side 43 and the second side 47 are shown at a right angle relative to each other.

As appreciated the specific angle between the first side 43 and the second side 47 are application specific and is adjusted to reflect light transmitted through the shaft 28 through the pointer 18. The top surface 45 in concert with the first side 43 and second side 47 control the amount of luminance that eventually reaches the center 24. As appreciated, it is desirable to provide a substantially even and consistent luminance level throughout the pointer 18. Further, the diffuser 26 is fabricated from a translucent material having desired light absorption and reflective properties to both reflect a portion of light through the pointer 18 and absorb or scatter a portion of light to create a substantially uniform light intensity throughout the entire pointer 18.

Referring to FIG. 7, a cross-section of the pointer 18 is shown and includes the top surface 50, the bottom surface 52 and the sides 55. The tops surface 50 is of a width 56 that is greater than a width 54 of the bottom surface 52. The difference between the top width 56 and the bottom width 54 provides the desired and consistent illumination throughout the pointer 18. Adjustment of a height 57 and the widths 56, 54 create a light path that operates in concert with the first and second reflecting surfaces 44,46 of the diffuser 26 to produce the desired uniform luminance throughout the pointer 18.

Referring to FIGS. 8 and 9, the cap 36 fits over the pointer 18 but does not cover the center 24. The cap 36 includes a slot 60 for receiving the pointer 18. The cap 36 fits over the pointer 18 and includes posts 62. The posts 62 extend from the cap 36 to engage openings 58 defined within the diffuser 26. Although the top surface 50 of the pointer 18 is exposed, the cap 36 covers the sides of the pointer 18 adjacent the center 24. The cap 36 therefore blocks emission of light that can leak through from the light source 30 on the PCB 32. Although a circular shape of the cap 36 is shown, it is within the contemplation of this invention to utilize other shapes as is desired.

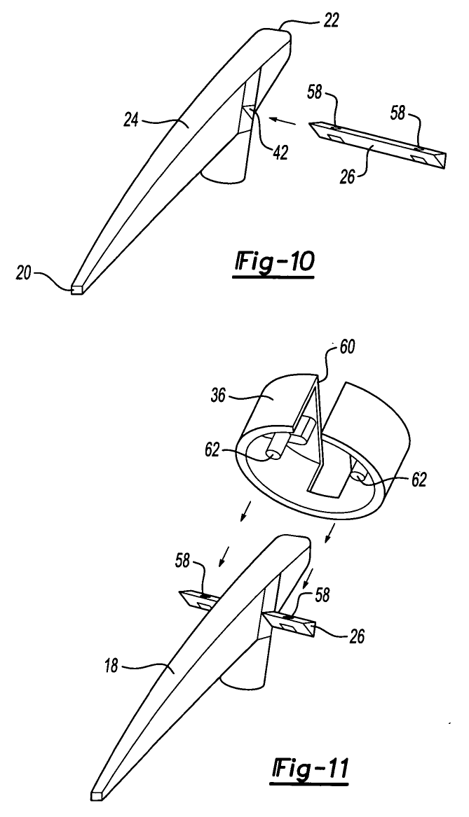

Referring to FIGS. 10 and 11, the pointer 18 is assembled by inserting the diffuser 26 into the cavity 42. The cavity 42 is sized to provide a light interference fit with the diffuser 26. The light interference fit holds the diffuser 26 in place. The diffuser 26 extends from each side of the pointer 18 to expose the openings 58. The cap 36 is then assembled to the pointer 18 by inserting the pointer 18 through the slot 60 and inserting the posts 58 within the openings 58.

The pointer 18 of this invention includes the diffuser 26 that diffuses light from the light source 30 to provide a substantially uniform luminance along the pointer 18 regardless of radial position. Further, the position of the light source 30 along the axis 40 provides a consistent relative orientation between the light source 30 and the diffuser 26 regardless of the radial position of the pointer 18. The consistent relative orientation between the light source 30 and the pointer 18 substantially eliminates differences in illumination levels produced during rotation about the axis 40.

Although a preferred embodiment of this invention has been disclosed, a worker of ordinary skill in this art would recognize that certain modifications would come within the scope of this invention. For that reason, the following claims should be studied to determine the true scope and content of this invention.

1. An illuminated pointer assembly for an instrument panel comprising:
a pointer including a tip and a center portion;
a shaft supporting said pointer for rotation; and
a diffuser supported within said pointer for transmitting light communicated through said shaft toward said tip

2. The assembly as recited in claim 1 wherein said pointer includes a center portion and said diffuser controls luminance emitted through said center portion.

3. The assembly as recited in claim 1 wherein said pointer includes a tail and said diffuser reflects light toward said tip and toward said tail.

4. The assembly as recited in claim 2 wherein said pointer includes a cavity within said center portion for said diffuser.

5. The assembly as recited in claim 1 wherein said diffuser includes at least one reflective surface for directing light through said pointer.

6. The assembly as recited in claim 3 wherein said diffuser includes a first reflective surface for communicating light toward said tip and a second reflective surface for communicating light toward said tail.

7. The assembly as recited in claim 2 wherein said diffuser includes a translucent material that controls transmission of light toward said center portion of said pointer.

8. The assembly as recited in claim 6 wherein said shaft is disposed along an axis of rotation and a said first and second reflective surfaces are disposed along said axis of rotation.

9. The assembly as recited in claim 1 including a cap disposed over said pointer.

10. The assembly as recited in claim 9 wherein said diffuser mates with said cap for retaining said cap in position on said pointer.

11. The assembly as recited in claim 1 wherein said pointer includes a top surface and a bottom surface said top surface having a width greater then said bottom surface.

12. The assembly as recited in claim 11 including a reflective coating disposed on at least a portion of said bottom surface.

13. An instrument dial assembly including an illuminated pointer comprising:
a rotatable translucent shaft;
a face panel including a graphical display; and
a pointer mounted to said translucent shaft for indicating on said face panel, said pointer including a diffuser adjacent said translucent shaft for transmitting light toward a tip of said pointer and diffusing transmission of light through a center portion of said pointer.

14. The assembly as recited in claim 13 wherein said pointer includes a cavity for receiving said diffuser.

15. The assembly as recited in claim 14 wherein said pointer includes a tail opposite said tip and said diffuser directs light toward said tip and said tail.

16. The assembly as recited in claim 15 wherein said diffuser includes a first reflective surface for directing light to said tip and a second reflective surface for reflecting light toward said tail.

17. The assembly as recited in claim 16 wherein said diffuser comprises a translucent material for reflecting light toward said tip and said tail and blocking a portion of light transmitted to a center portion of said pointer.
